(19) United States
(12) Patent Application Publication
(10) Pub. No.: US 2010/0177390 A1
(43) Pub. Date: Jul. 15, 2010

(54) WAVELENGTH DEPENDENT OPTICAL ELEMENTS AND APPLICATIONS THEREOF

(76) Inventor: Robert Hutchins, Charlotte, NC (US)

Correspondence Address: Tessera North America, Inc., c/o Kilpatrick Stockton LLP, 1001 West Fourth Street, Winston-Salem, NC, 27101, US

(21) Appl. No.: 12/630,557

(22) Filed: Dec. 3, 2009

Related U.S. Application Data
(60) Provisional application No. 61/119,536, filed on Dec. 3, 2008.

(51) Int. Cl. G02B 5/18

(52) U.S. Cl. 359/572

(57) ABSTRACT

The present invention provides an optical element operable to display a plurality of distinct images when irradiated with various wavelengths of electromagnetic radiation. The ability to output a plurality of distinct images can permit the use of optical elements of the present invention in a variety of apparatus and imaging applications.

### RELATED U.S. APPLICATION DATA

The present application claims priority under 35 U.S.C. §119(e) to U.S. Provisional Patent Application Ser. No. 61/119,536, filed Dec. 3, 2008, which is hereby incorporated by reference in its entirety.

### FIELD OF THE INVENTION

The present invention relates to optical devices and, in particular, to diffractive optical devices.

### BACKGROUND OF THE INVENTION

Optical elements operable to produce patterns in conjunction with an applied source of electromagnetic radiation have become increasingly important in the storage of data and other information as well security applications. Diffractive optical elements including holographic optical elements, for example, have been used in various information storage and imaging applications.

Significant disadvantages, however, exist in using optical elements for information storage and imaging applications. One disadvantage is the substantial difficulty or even inability to alter the media of the optical element for subsequent information storage or imaging applications once information corresponding to a first output image is recorded thereon. Holographic optical elements demonstrate such a disadvantage in being limited to the interference pattern recorded thereon.

As a result of such limitations, an apparatus incorporating a holographic optical element for the display of information to a user in an image format requires a plurality of such elements if displaying more than one image is desired. Incorporating a plurality of holographic optical elements into an apparatus increases the operational complexity, size and cost of the apparatus.

### SUMMARY

In view of the foregoing disadvantages, the present invention provides an optical element operable to output a plurality of distinct images. The ability to output a plurality of distinct images can render optical elements of the present invention suitable for use in a variety of apparatus and applications for communicating information to a user in an output image format.

In some embodiments, an optical element of the present invention comprises a first wavelength-dependent reflective layer comprising a first surface relief structure having a first optical output image and a second wavelength-dependent reflective layer comprising a second surface relief structure having a second output image. The term wavelength-dependent, as used herein, refers to the ability to reflect electromagnetic radiation of a first wavelength or first range of wavelengths while passing electromagnetic radiation of a second wavelength or second range of wavelengths. Individual wavelength-dependent reflective layers of optical elements of the present invention demonstrate different wavelength selectivity.

In some embodiments, an optical element of the present invention further comprises at least one additional wavelength-dependent reflective layer comprising a third surface relief structure comprising a third optical output image. Optical elements of the present invention contemplate any number of wavelength-dependent reflective layers, each layer comprising a surface relief structure comprising an optical output image.

In another aspect, the present invention provides apparatus comprising an optical element, the optical element comprising a first wavelength-dependent reflective layer comprising a first surface relief structure having a first optical output image and a second wavelength-dependent reflective layer comprising a second surface relief structure having a second output image. Apparatus incorporating an optical element of the present invention, in some embodiments, comprise one or a plurality of detection elements operable to detect user interaction with an output image of the optical element for applications such as data entry.

In a further aspect, the present invention provides methods of displaying images. In one embodiment, a method of displaying an image comprises providing an optical element comprising a first wavelength-dependent reflective layer comprising a first surface relief structure having a first optical output image and a second wavelength-dependent reflective layer comprising a second surface relief structure having a second optical output image and irradiating the optical element with electromagnetic radiation having a wavelength reflected by the first wavelength-dependent reflective layer or the second wavelength-dependent reflective layer to display the first optical output image or the second optical output image. In some embodiments, the optical element is irradiated with electromagnetic radiation having wavelengths reflected by the first and the second wavelength-dependent reflective layers to simultaneously display the first and second optical output images.

In another embodiment, a method of displaying an image comprises providing an optical element comprising a first wavelength-dependent reflective layer comprising a first surface relief structure having a first optical output image and a second wavelength-dependent reflective layer comprising a second surface relief structure having a second optical output image, irradiating the optical element with electromagnetic radiation having a wavelength reflected by the first wavelength-dependent reflective layer to display the first optical output image, and adjusting the source of electromagnetic radiation to irradiate the optical element with electromagnetic radiation having a wavelength reflected by the second wavelength-dependent reflective layer to display the second optical output image.

These and other embodiments are described in greater detail in the detailed description which follows.

### BRIEF DESCRIPTION OF THE FIGURES

FIG. 1 is a cross-sectional view of an optical element according to one embodiment of the present invention.

FIG. 2 is a cross-sectional view of an optical element illustrating interaction of electromagnetic radiation of various wavelengths with the optical element according to one embodiment of the present invention.

FIG. 3 illustrates the optical path of electromagnetic radiation through a wavelength-dependent reflective layer of an optical element according to one embodiment of the present invention.

FIG. 4 illustrates an apparatus incorporating an optical element according to one embodiment of the present invention.

### DETAILED DESCRIPTION

The present invention can be understood more readily by reference to the following detailed description, examples and drawings and their previous and following descriptions. Elements, apparatus and methods of the present invention, however, are not limited to the specific embodiments presented in the detailed description, examples and drawings. It should be recognized that these embodiments are merely illustrative of the principles of the present invention. Numerous modifications and adaptations will be readily apparent to those of skill in the art without departing from the spirit and scope of the invention.

The present invention provides an optical element operable to display a plurality of distinct images when irradiated with various wavelengths of electromagnetic radiation. The ability to output a plurality of distinct images can permit the use of optical elements of the present invention in a variety of apparatus and imaging applications.

In one embodiment, an optical element of the present invention comprises a first wavelength-dependent reflective layer comprising a first surface relief structure having a first optical output image and a second wavelength-dependent reflective layer comprising a second surface relief structure having a second output image.

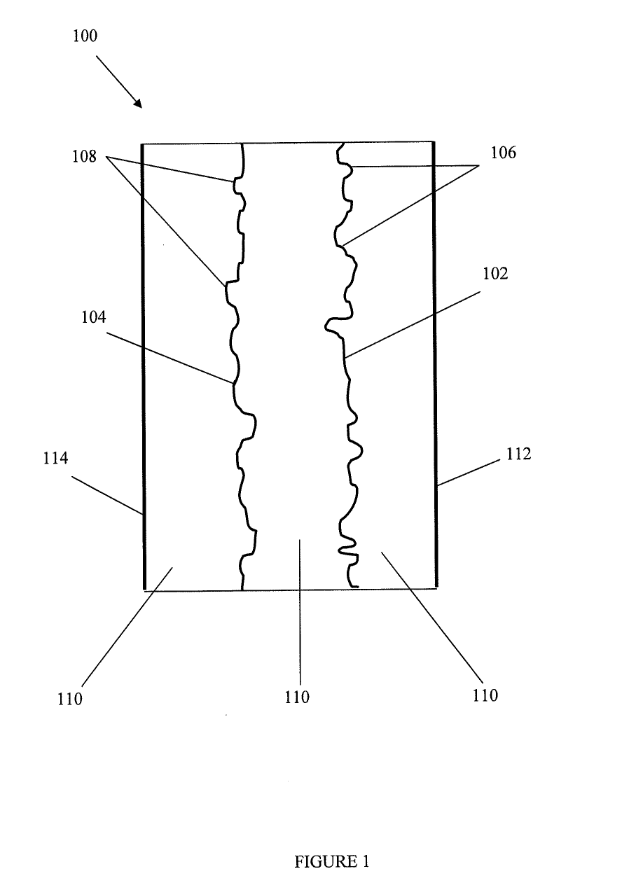

Referring now to the figures, FIG. 1 illustrates a cross-sectional view of an optical element according to one embodiment of the present invention. The optical element (100) of FIG. 1 comprises a first wavelength-dependent reflective layer (102) and a second wavelength-dependent reflective layer (104). The first wavelength-dependent reflective layer (102) comprises a surface relief structure (106) operable to produce an output image when irradiated with electromagnetic radiation of the proper wavelength or wavelengths for reflection by the first wavelength-dependent reflective layer. Moreover, the second wavelength-dependent reflective layer (104) also comprises a surface relief structure (108) operable to produce an output image when irradiated with electromagnetic radiation of the proper wavelength or wavelengths for reflection by the second wavelength-dependent reflective layer (104).

In some embodiments, the surface relief structure (106) of the first wavelength-dependent reflective layer (102) is different from the surface relief structure (108) of the second wavelength-dependent reflective layer (104), thereby resulting in the output of distinct images from the first and second layers (102, 104). In other embodiments, however, the surface relief structure (106) of the first wavelength-dependent reflective layer (102) and the surface relief structure (108) of the second wavelength-dependent reflective layer (104) produce the same or substantially the same output image. In such embodiments, the first and second wavelength-dependent reflective layers (102, 104) can serve as back-ups for one another in the event a source of electromagnetic radiation having one or more wavelengths suitable for being reflected by only one of the first or second layers (102, 104) is lost. In this latter embodiment, the surface relief structure (106) of the first wavelength-dependent reflective layer (102) and the surface relief structure (108) of the second wavelength-dependent reflective layer (104) are operable to produce the same or substantially similar output image but differ in construction as each is responsive to a different wavelength of electromagnetic radiation.

A surface relief structure of a wavelength-dependent reflective layer, according to some embodiments of the present invention, comprises a diffractive structure. A diffractive surface relief structure of a wavelength-dependent reflective layer diffracts electromagnetic radiation interacting with the layer to produce an optical output image. In some embodiments, a diffractive surface relief structure comprises a surface relief hologram.

In other embodiments, a surface relief structure of a wavelength-dependent reflective layer comprises reflective structures which are not diffractive. In some embodiments, for example, such reflective structures comprise one or a plurality of lens-shaped reflective surfaces including convex and concave surfaces. In another embodiment, reflective structures comprise prismatic shapes, including various polygonal shapes.

In a further embodiment, the final or last wavelength-dependent reflective layer of an optical element with which electromagnetic radiation interacts comprises reflective structures and/or refractive structures. In some embodiments, refractive structures comprise lenses or prismatic structures. In some embodiments, prismatic structures comprise right angle prisms, penta prisms, porro prisms, dove prisms, anamorphic prisms or rhomboid prisms or combinations thereof.

In comprising refractive structures, in some embodiments, the final or last wavelength-dependent reflective layer of an optical element to interact with electromagnetic radiation can alter the wavefront of the electromagnetic radiation.

Wavefront alteration at the final or last wavelength-dependent reflective layer to interact with electromagnetic radiation does not affect the performance of any other wavelength-dependent reflective layer of the optical element.

A surface relief structure of a wavelength-dependent reflective layer can be produced according to a variety of methods. In one embodiment, a diffractive surface relief structure of a wavelength-dependent reflective layer is produced by computer generated holographic (CGH) techniques. In computer generated holography, the desired interference pattern is determined by computer calculations. The results of the computer calculations are subsequently used to produce the surface structure corresponding to the desired interference pattern of the wavelength-dependent reflective layer by various techniques including laser direct write, electron beam direct write, diamond turning or photolithographic methods such as those disclosed in U.S. Pat. Nos. 4,895,790, 5,161,059 and 5,218,471 which are hereby incorporated by reference in their entirety. Moreover, in some embodiments, computer generated holograms are produced according the disclosure of U.S. Pat. No. 6,005,714 which is hereby incorporated by reference in its entirety.

Alternatively, in some embodiments, a surface relief structure of a wavelength-dependent reflective layer is produced by exposing a photosensitive material to an interference pattern generated by a reference beam and object beam.

Once the desired surface relief structure is produced, the surface relief structure is coated with a wavelength-dependent reflection coating that conforms to the surface relief structure. Coating the surface relief structure with a wavelength-dependent reflection coating provides the desired electromagnetic radiation response selectivity thereby completing construction of the wavelength-dependent reflection layer.

A wavelength-dependent reflective coating can comprise any coating material known to one of skill in the art operable to impart the desired wavelength selectivity to the layer. In some embodiments, a wavelength-dependent reflective coating comprises a metallic coating. Metallic coatings, according to some embodiments, comprise elementally pure metals, alloys or metal oxides or combinations thereof. In other embodiments, a wavelength-dependent reflective coating comprises a dielectric mirror comprising a stack of dielectric layers.

In some embodiments, a wavelength-dependent reflective coating is applied to a surface relief structure of a wavelength-dependent reflective layer by chemical vapor deposition (CVD) processes. In another embodiment, a wavelength-dependent reflective coating is applied to a surface relief structure of a wavelength-dependent reflective layer by physical vapor deposition (PVD) processes, such as sputtering. In some embodiments, a wavelength-dependent reflective coating is applied to a surface relief structure by solution casting or spin casting processes.

A wavelength-dependent reflective layer, in some embodiments, has a thickness less than about 0.2 μm. In some embodiments, a wavelength-dependent reflective layer has a thickness less than about 0.1 μm. In other embodiments, a wavelength-dependent reflective layer has a thickness less than about 75 nm or less than about 50 nm. In a further embodiment, a wavelength-dependent reflective layer has a thickness greater than 0.2 μm or less than about 50 nm.

Referring once again to FIG. 1, the optical element (100) further comprises a plurality of immersion layers (110) which spatially separate the wavelength-dependent reflection layers (102, 104) from one another as well as from the faces (112, 114) of the optical element (100). Immersion layers are radiation transmissive and do not interact or substantially interact with electromagnetic radiation received by the optical element (100). As illustrated in FIG. 1, in some embodiments, the first, second and/or any additional wavelength-dependent reflective layers are in a stacked configuration.

Materials suitable for use as an immersion layer can comprise any material known to one of skill in the art. In some embodiments, an immersion layer is constructed of a polymeric material comprising a polycarbonate or polyacrylates such as polyacrylic acid polymethacrylate, polymethylmethacrylate or mixtures thereof. In another embodiment, a suitable polymeric material for an immersion layer comprises perfluorocyclobutane (PFBC) containing polymers, such as perfluorocyclobutane poly(arylether)s. In some embodiments, an immersion material comprises glass including spin-on glass.

An immersion layer, in some embodiments, has a thickness ranging from about 1 μm to about 1 mm. In some embodiments, an immersion layer has a thickness ranging from about 5 μm to about 500 μm or from about 10 μm to about 250 μm. In another embodiment, an immersion layer has a thickness ranging from about 30 μm to about 100 μm. In a further embodiment, an immersion layer has a thickness less than about 1 μm or greater than about 1 mm.

An immersion layer can be applied in the fabrication of optical elements of the present invention by a variety of processes including solution casting processes and spin casting processes.

In some embodiments in the construction of an optical element of the present invention, a wavelength-dependent reflective layer comprising a surface relief structure is formed on a substrate comprising an immersion material. Forming a wavelength-dependent reflective layer comprising a surface relief structure on a substrate comprising an immersion material integrally couples at least one side of the wavelength-reflective layer to the immersion layer.

In one embodiment, for example, a first wavelength-dependent reflective layer comprising a first surface relief structure is formed on a surface of a first immersion layer. A second wavelength-dependent layer comprising a second surface relief structure is formed on a surface of a second immersion layer. In some embodiments, the first and second immersion layers comprise the same material. In embodiments wherein the first and second immersion layers comprise different materials, the first and second immersion materials demonstrate the same or substantially the same index of refraction.

The two immersion layers each comprising a wavelength-dependent reflective layer can be subsequently combined to produce an optical element of the present invention. The surface relief structure of the second wavelength-dependent reflective layer, for example, can be coated with an index matching adhesive material and bonded to the flat, non-patterned surface of the first immersion layer to produce an optical element of the present invention. The foregoing process can be repeated for any number of desired wavelength-dependent reflective layers.

In some embodiments, wafer level techniques can be employed to produce a plurality of immersion layers, each immersion layer comprising a surface having a wavelength-dependent reflective layer comprising a surface relief structure. In one embodiment, for example, a glass wafer is provided and a plurality of surface relief structures are generated on a surface of the wafer. The surface relief structures are coated with a wavelength-dependent reflection coating and subsequently separated from one another to produce a plurality of immersion layers, each layer comprising a wavelength-dependent reflective layer comprising a surface relief structure. The individual immersion layers can then be used in the construction of an optical element as described herein.

Referring once again to FIG. 1, an optical element (100) can further comprise a protective layer (not shown) on the faces (112, 114) of the optical element (100). A protective layer in some embodiments, adds mechanical stability while providing the optical element (100) with desirable properties including scratch and dent resistance. A protective layer is additionally radiation transmissive and does not interact or substantially interact with electromagnetic radiation received by the optical element.

In some embodiments, an optical element of the present invention comprises at least one additional wavelength-dependent reflective layer comprising a third surface relief structure comprising a third optical output image. Embodiments of the present invention contemplate any number of wavelength-dependent reflective layers, each layer comprising a surface relief structure comprising an optical output image. In some embodiments, an optical element of the present invention comprises at least 10 wavelength-dependent reflective layers. In another embodiment, an optical element comprises at least 5 wavelength-dependent reflective layers. In some embodiments, an optical element comprises at least 4 or at least 3 wavelength-dependent reflective layers.

An optical output image of a surface relief structure of a wavelength-dependent reflective layer can comprise any desired image. In some embodiments, an optical output image of a surface relief structure of a wavelength dependent reflective layer comprises a data entry device. In some embodiments, a data entry device comprises a keyboard, calculator, menu, phone, personal digital assistant (PDA) or combinations thereof. In other embodiments an optical output image of a surface relief structure of a wavelength-dependent reflective layer comprises controls for an electronic device. In some embodiments, an electronic device comprises a computer, radio, television, phone such as a cellular phone, PDA, camera or global positioning system (GPS). In some embodiments, an optical output image of a surface relief structure of a wavelength-dependent reflective layer comprises a menu for an appliance. An appliance, in some embodiments, comprises a refrigerator, dishwasher, washing machine, dryer, oven or microwave. In a further embodiment, an optical output image of a surface relief structure of a wavelength-dependent reflective layer comprises data. Data, according to some embodiments, comprises letters, characters, symbols, numbers, words or combinations thereof.

In another aspect, the present invention provides methods of displaying images. In one embodiment, a method of displaying an image comprises providing an optical element comprising a first wavelength-dependent reflective layer comprising a first surface relief structure having a first optical output image and a second wavelength-dependent reflective layer comprising a second surface relief structure having a second optical output image and irradiating the optical element with electromagnetic radiation having a wavelength reflected by the first wavelength-dependent reflective layer or the second wavelength-dependent reflective layer to display the first optical output image or the second optical output image. In some embodiments, the optical element is irradiated with electromagnetic radiation having wavelengths reflected by the first and the second wavelength-dependent reflective layers to simultaneously display the first and second optical output images.

In another embodiment, a method of displaying an image comprises providing an optical element comprising a first wavelength-dependent reflective layer comprising a first surface relief structure having a first optical output image and a second wavelength-dependent reflective layer comprising a second surface relief structure having a second optical output image; irradiating the optical element with electromagnetic radiation having a wavelength reflected by the first wavelength-dependent reflective layer to display the first optical output image; and adjusting the source of electromagnetic radiation to irradiate the optical element with electromagnetic radiation having a wavelength reflected by the second wavelength-dependent reflective layer to display the second optical output image.

Output images displayed by surface relief structures of wavelength-dependent reflective layers of optical elements of the present invention, in some embodiments, comprise any of the images described herein. Moreover, in some embodiments, optical elements of the present invention are irradiated with ultraviolet electromagnetic radiation, visible electromagnetic radiation or infrared electromagnetic radiation or combinations thereof.

Sources of electromagnetic radiation, in some embodiments, comprise black body sources. In some embodiments, black body sources are used in conjunction with interference filters to provide a tunable wavelength output. In other embodiments, narrow bandwidth or monochromatic sources of electromagnetic radiation are used including lasers or light emitting diodes. In some embodiments, multiple sources of electromagnetic radiation are used wherein each source provides electromagnetic radiation for interaction with at least one wavelength-dependent reflective layer of an optical element of the present invention. In other embodiment, a tunable source of electromagnetic radiation is used to provide electromagnetic radiation for interaction with each of a plurality of wavelength-dependent reflective layers of an optical element.

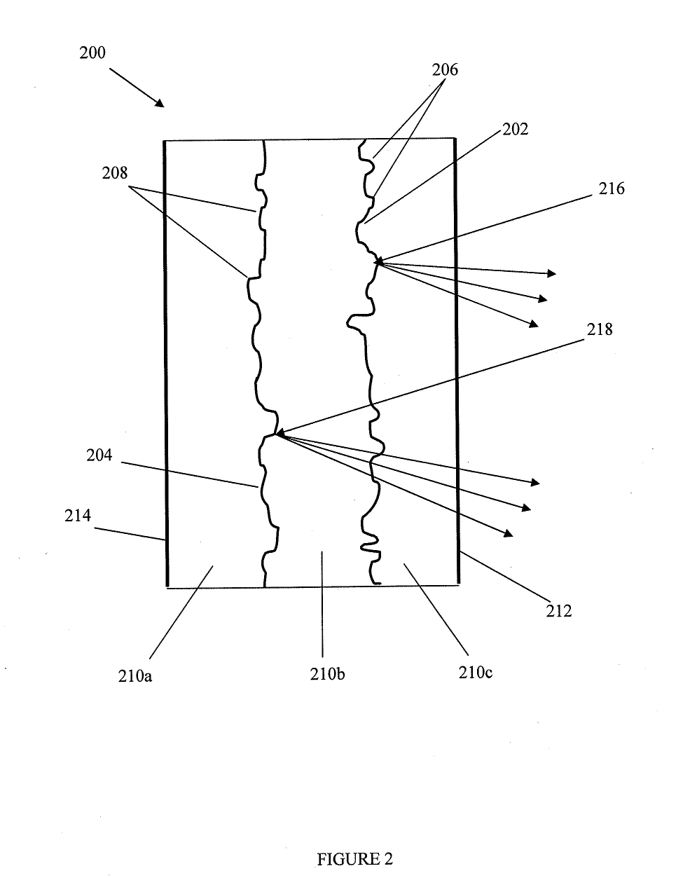

FIG. 2 is a cross-sectional view of an optical element illustrating interaction of electromagnetic radiation of various wavelengths with the optical element according to one embodiment of a method of the present invention. As displayed in FIG. 2, the optical element (200) comprises a first wavelength-dependent reflective layer (202) and a second wavelength reflective layer (204). The first wavelength-dependent reflective layer (202) comprises a surface relief structure (206) operable to produce an optical output image when irradiated with electromagnetic radiation of the proper wavelength or wavelengths for reflection by the first wavelength-dependent reflective layer (202). Moreover, the second wavelength-dependent reflective layer (204) also comprises a surface relief structure (208) operable to produce an optical output image when irradiated with electromagnetic radiation of the proper wavelength or wavelengths for reflection by the second wavelength-dependent reflective layer (204).

The optical element (202) additionally comprises a plurality of immersion layers (210a, 210b, 210c) which spatially separate the wavelength-dependent reflection layers (202, 204) from one another as well as from the front face (212) and the rear face (214) of the optical element (200).

The optical element (200) is irradiated with electromagnetic radiation (216) of a first wavelength or range or wavelengths. The electromagnetic radiation (216) meets the selectivity of the first wavelength-dependent reflective layer (202) and is reflected according to the surface relief structure (206) to produce a first output image. In embodiments wherein the surface relief structure (206) is a diffractive structure, the electromagnetic radiation (216) is diffracted by the first wavelength-dependent reflective layer (202).

Electromagnetic radiation (218) not meeting the selectivity requirements of the first wavelength-dependent reflective layer (202) passes through the first wavelength-dependent reflective layer (202) to the second wavelength-dependent reflective layer (204). If the electromagnetic radiation (218) meets the selectivity requirements of the second wavelength-dependent reflective layer (204), the electromagnetic radiation (218) is subsequently reflected according to the surface relief structure (208) of the second wavelength-dependent reflective layer (202) to produce a second optical output image. In embodiments wherein the surface relief structure (208) is a diffractive structure, the electromagnetic radiation (218) is diffracted by the second wavelength-dependent reflective layer (204).

The thicknesses of the immersion layers (210a, 210b, 210c) may be similar or different depending on a particular application. In certain embodiments, additional thickness may be appropriate where rigidity is a concern. In other embodiments where size is a determining factor, thinner immersion layers (210a, 210b, 210c) may be used. In one embodiment, immersion layer (210a) at the rear face (214) of the optical element (200) may be very thin or non-existent since if the optical element (200) is configured so that no light passes beyond the rear-most surface relief structure (208).

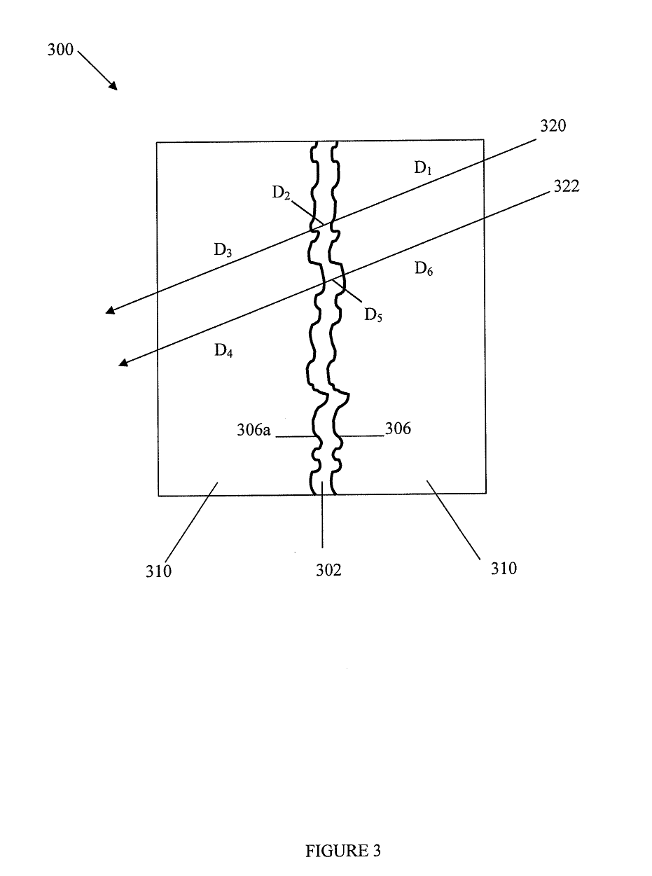

The foregoing process can be repeated for any number of wavelength-dependent reflective layers in the optical element. Moreover, although an optical element of the present invention presents a layered structure, electromagnetic radiation applied to the optical element, in some embodiments, experiences no optical path length difference at any location of the optical element other than the sidewall regions. FIG. 3 illustrates this principle by displaying the optical path of electromagnetic radiation across a single reflection layer (302) of an optical element (300) according to one embodiment of the present invention. FIG. 3 displays a detailed section on optical element (300) comprising a wavelength-dependent reflective layer (302) having surface relief structure (306). The relief structure (306) at the leading side of the wavelength-dependent reflective layer (302) and the relief structure (306a) at the trailing side of the wavelength-dependent reflective layer (302) may be substantially similar in form, particularly if a conformal material or uniform-thickness material is used to create the wavelength-dependent reflective layer (302). The optical element (300) additionally comprises immersion layers (310) on both sides of the wavelength-dependent reflective layer (302).

A first ray of electromagnetic radiation (320) enters the optical element (300) and traverses the thickness (D₁) of the first immersion layer (310) to reach the wavelength-dependent reflective layer (302). The first ray of electromagnetic radiation (320) has a wavelength that does not meet the selectivity requirements of the wavelength-dependent reflective layer (302) and, therefore, passes through and traverses the thickness (D₂) of the wavelength-dependent reflective layer (302). The first ray of electromagnetic radiation (320) continues on to traverse the thickness (D₃) of the second immersion layer (310).

A second ray of electromagnetic radiation (322) enters the optical element (300) at a different point than the first ray (320) and traverses the thickness (D₆) of the first immersion layer (310) to reach the wavelength-dependent reflective layer (302). The second ray of electromagnetic radiation (322) has a wavelength that also does not meet the selectivity requirements of the wavelength-dependent reflective layer (302) and, therefore, passes through and traverses the thickness (D₅) of the wavelength-dependent reflective layer (302). The first ray of electromagnetic radiation (320) continues on to traverse the thickness (D₄) of the second immersion layer (310).

As illustrated in FIG. 3, the first (320) and second (322) rays of electromagnetic radiation pass through the wavelength-dependent reflective layer (302) at different locations. Due to the variability of the surface relief structure (306) of the wavelength-dependent reflective layer (302), the first (320) and second (322) rays of electromagnetic radiation experience different thicknesses when traversing the wavelength-dependent reflective layer (302) in that D₂ does not equal D₅. However, the first (320) and second (322) rays of electromagnetic radiation do not experience different or substantially different optical path lengths since (D₁+D₂+D₃)=(D₄+D₅+D₆).

Referring once again to FIG. 2, in some embodiments, an optical element is irradiated with electromagnetic radiation comprising one or more wavelengths reflected by the first (202) and second (204) wavelength-dependent reflective layers to simultaneously display the first and second output images. Such an arrangement may be desirable if the first and second output images complement one another. In one embodiment, for example, the first output image is a grid for a virtual keyboard, and the second output image presents letters and numbers for the virtual keyboard.

As provided herein, in other embodiments, an optical element is irradiated with electromagnetic radiation comprising one or more wavelengths meeting the selection requirements of only the first (202) or the second (204) wavelength-dependent reflective layer. In such embodiments, only the first output image of the first wavelength-dependent reflective layer (202) or the second output image of the second wavelength-dependent reflective layer is displayed, thereby providing the ability to selectively display images according to the wavelength(s) of the applied electromagnetic radiation.

Accordingly, a user of the optical element can select the desired image to display by selecting the proper wavelength(s) of applied radiation. When a user is done with the display of a first optical output image of a first wavelength-dependent reflective layer, the user can adjust or switch the source of electromagnetic radiation to provide proper wavelength(s) to pass through the first wavelength-dependent reflective layer and interact with the second wavelength-dependent reflective layer to display the second optical output image. Alternatively, when a user is done with the display of a second output image of the second wavelength-dependent reflective layer, the user can adjust the source of electromagnetic radiation to interact with the first wavelength-dependent reflective layer to produce the first optical output image.

In a further aspect, the present invention provides apparatus comprising an optical element, the optical element comprising a first wavelength-dependent reflective layer comprising a first surface relief structure having a first optical output image and a second wavelength-dependent reflective layer comprising a second surface relief structure having a second optical output image. In some embodiments, apparatus incorporating an optical element of the present invention comprise electronic devices including, but not limited to, computers, calculators, phones, cameras, GPS or PDAs. In other embodiments, apparatus incorporating an optical element of the present invention comprise appliances. In some embodiments, an appliance comprises a refrigerator, dishwasher, washing machine, dryer, oven or microwave.

Apparatus incorporating an optical element of the present invention, in some embodiments, comprise one or a plurality of detection elements operable to detect user interaction with an output image of the optical element. In one embodiment, for example, a computer incorporates an optical element of the present invention to display a virtual keyboard. In order to recognize user interaction with keys of the virtual keyboard, the computer comprises one or a plurality of detection elements operable to determine the striking of the virtual keys by the user.

In some embodiments, an infrared output image generated by at least one of the plurality of wavelength-dependent reflective layers of an optical element of the present invention is overlayed on a visible output image generated by the same optical element. A detection element of the apparatus is operable to sense user interaction with the overlayed infrared image. Embodiments of the present invention contemplate the use of any region of the electromagnetic spectrum as an overlay for use in conjunction with one or more detection elements in determining user interaction with an output image.

In another embodiment, an electronic device incorporates an optical element of the present invention to display virtual controls for the electronic device. In order to recognize user interaction with the displayed controls, the electronic device comprises one or a plurality of detection elements operable to determine the touching of the displayed controls by the user. Moreover, a user can adjust the source of electromagnetic radiation irradiating the optical element of the electronic device, as described herein, to display images of different controls of the device.

In a further embodiment, an appliance incorporates an optical element of the present invention to display virtual menus or settings of the appliance. In order to recognize user interaction with the menus or settings, the appliance comprises one or a plurality of detection elements operable to determine the touching of the displayed menus by the user. Additionally, a user can adjust the source of electromagnetic radiation irradiating the optical element of the appliance, as described herein, to display images of different menus or settings of the appliance.

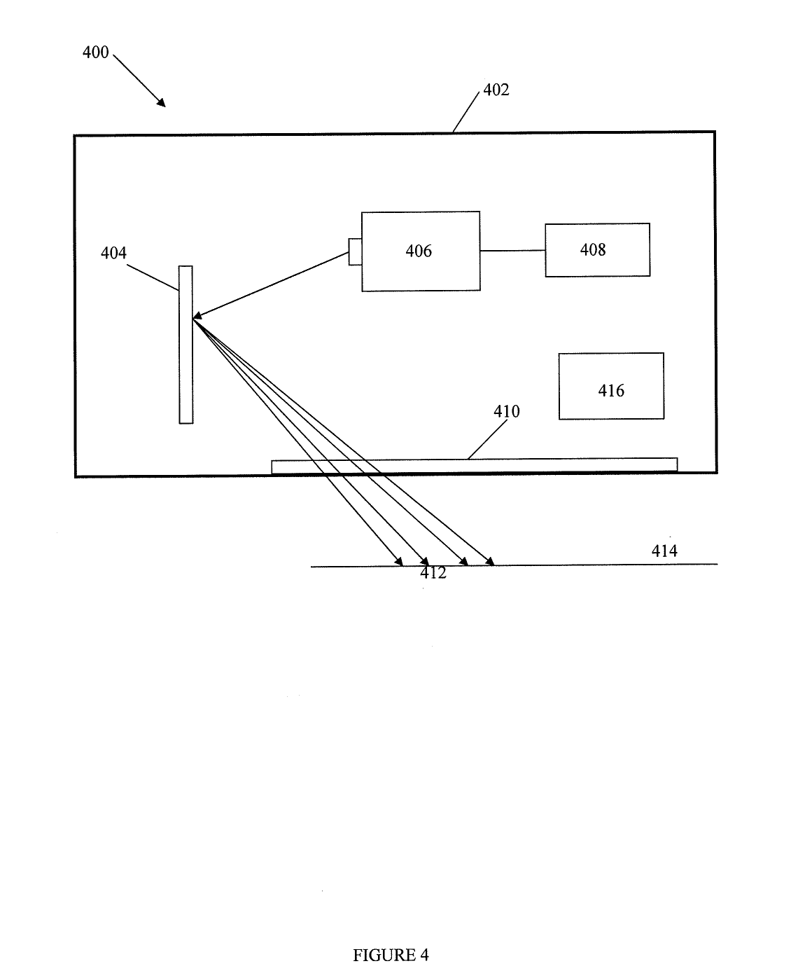

FIG. 4 illustrates an apparatus incorporating an optical element according to one embodiment of the present invention. As illustrated in FIG. 4, the apparatus (400) comprises a housing (402) and an optical element (404) of the present invention disposed within the housing (402). A source of electromagnetic radiation (406) is also disposed within the housing (402) in a position to irradiate the optical element (404). A controller (408) is coupled to the source of electromagnetic radiation (406). The controller permits a user of apparatus (400) to adjust the source of electromagnetic radiation (406) to display the desired output image of the optical element (404) according to wavelength as described herein. The housing (402) further comprises a window or aperture through which the output image (412) is transmitted to a surface (414). The apparatus further comprises a detection element (416) operable to determine user interaction with the displayed output image (412).

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

That which is claimed is:

1. An optical element comprising:
a first wavelength-dependent reflective layer comprising a first surface relief structure having a first optical output image; and
a second wavelength-dependent reflective layer comprising a second surface relief structure having a second optical output image.

2. The optical element of claim 1 further comprising at least one additional wavelength-dependent reflective layer comprising a third surface relief structure comprising a third optical output image.

3. The optical element of claim 1, wherein the first surface relief structure comprises a diffractive structure.

4. The optical element of claim 3, wherein the diffractive structure comprises a holographic structure.

5. The optical element of claim 4, wherein the holographic structure comprises a computer generated holographic structure.

6. The optical element of claim 1, wherein the first optical output image and the second optical output image are different.

7. The optical element of claim 1, wherein the first optical output image comprises a data entry device.

8. The optical element of claim 7, wherein the data entry device comprises a keyboard, calculator, menu, keypad, phone, personal digital assistant or combinations thereof.

9. The optical element of claim 1, wherein the first optical output image comprises a musical instrument.

10. The optical element of claim 9, wherein the musical instrument comprises a piano, guitar or keyboard.

11. The optical element of claim 1, wherein the first optical output image comprises data.

12. The optical element of claim 11, wherein the data comprises letters, words, numbers or combinations thereof.

13. The optical element of claim 1, wherein the first optical output image comprises controls for an electronic device.

14. The optical element of claim 13, wherein the electronic device comprises a radio, television or phone.

15. The optical element of claim 1, wherein the first optical output image comprises controls or a menu for an appliance.

16. The optical element of claim 1 further comprising a first immersion layer and a second immersion layer.

17. The optical element of claim 16, wherein the first immersion layer and the second immersion layer have substantially the same index of refraction.

18. The optical element of claim 16 having substantially the same optical path length for a first ray of electromagnetic radiation and a second ray of electromagnetic radiation passing through the optical element at different locations.

19. The optical element of claim 16, wherein the first wavelength-dependent layer and the second wavelength-dependent layer are in a stacked configuration.

20. A method of displaying at least one optical pattern comprising:
providing an optical element comprising:
a first wavelength-dependent reflective layer comprising a first surface relief structure having a first optical output pattern and a second wavelength-dependent reflective layer comprising a second surface relief structure having a second optical output pattern; and
irradiating the optical element with electromagnetic radiation having a wavelength reflected by the first wavelength-dependent reflective layer or the second wavelength-dependent layer to display the first optical output pattern or the second optical output pattern.

21. The method of claim 20, wherein the electromagnetic radiation comprises wavelengths reflected by the first wavelength-dependent reflective layer and the second wavelength-dependent layer to display the first optical output pattern and the second optical output pattern.

22. The method of claim 21, wherein the first optical output pattern and the second optical output pattern are displayed simultaneously.

23. The method of claim 20, wherein the first optical output pattern and the second optical output pattern are different.

24. The method of claim 20, wherein the electromagnetic radiation comprises ultraviolet radiation, visible radiation, infrared radiation or combinations thereof.

25. A method of displaying an optical pattern comprising:
providing an optical element comprising:
a first wavelength-dependent reflective layer comprising a first surface relief structure having a first optical output pattern and a second wavelength-dependent reflective layer comprising a second surface relief structure having a second optical output pattern;
irradiating the optical element with electromagnetic radiation having a wavelength reflected by the first wavelength-dependent reflective layer to display the first optical output pattern; and
adjusting the electromagnetic radiation to have a wavelength reflected by the second wavelength-dependent reflective layer to display the second optical output pattern.

26. The method of claim 25, wherein the first optical output pattern and the second optical output pattern are different.
